(19) United States
(12) Patent Application Publication
(10) Pub. No.: US 2022/0014025 A1
(43) Pub. Date: Jan. 13, 2022

(54) FEED-IN METHOD FOR A WIND POWER SYSTEM, AND WIND POWER SYSTEM

(71) Applicant: Wobben Properties GmbH, Aurich (DE)

(72) Inventor: Johannes BROMBACH, Berlin (DE)

(21) Appl. No.: 17/294,963

(22) PCT Filed: Nov. 19, 2019
(86) PCT No.: PCT/EP2019/081785

§ 371 Date: May 18, 2021

(30) Foreign Application Priority Data
Nov. 22, 2018 (DE) 10 2018 129 429.8

(51) Int. Cl. H02J 3/38; H02J 3/00; H02J 13/00; H02J 3/46; G05B 19/042

(52) U.S. Cl. CPC H02J 3/381; H02J 3/004; H02J 13/00002; G05B 2219/2639; G05B 19/042; H02J 2300/28; G05B 2219/2619; H02J 3/46

(57) ABSTRACT

A method for feeding in electrical power, using a wind power system including a wind farm, into a grid at a grid connection point is provided. The grid has a distribution grid and a further higher portion of the grid lying hierarchically above the distribution grid. The grid connection point is connected to the distribution grid. The method includes detecting an initial feed-in limitation with respect to the grid connection point. The method includes checking whether the farm power that can be generated from wind by the wind farm is limited by the initial feed-in limitation so that the wind farm is throttled in its power output by the initial power limit. The method includes evaluating whether the initial power limit can be increased by a redistribution of the limitation, increasing the initial power limit to an increased power limit and feeding in electrical power above the initial power limit.

### BACKGROUND

### Technical Field

The present invention relates to a method for feeding in electrical power by means of a wind power system. The invention also relates to a wind power installation, a wind farm and a wind power system which comprises at least one wind farm.

### Description of the Related Art

Wind power installations and wind farms are sufficiently well known; they feed power obtained from wind into an electrical supply grid. Depending on the country, the proportion of such wind power installations, wind farms or wind power systems is becoming increasingly greater, and consequently their significance is also becoming greater. Unconditional parallel grid operation, in which wind power installations or wind farms always feed into the electrical supply grid as much power as they can generate at any given time on the basis of the prevailing wind and their technical capability is becoming increasingly unfeasible.

Often, for a whole variety of reasons, the electrical supply grid may have a power limitation for the feeding in of electrical power by wind power installations, wind farms or wind power systems.

Such limitations may be partly attributable to fully utilized grid capacities. This may be caused for example by more and more wind power installations or wind farms being connected to an existing grid. Particularly for reasons of their own protection and/or for reasons of stabilizing the grid or else for planning reasons, a corresponding limitation of the feed-in power may be prescribed. Such a limitation is often prescribed by a grid operator.

According to the document U.S. Pat. No. 6,724,097 there is a known solution which proposes connecting a wind farm to a grid connection point, the rated power or maximum possible feed-in power of the wind farm being greater than the connection capacity of the grid connection point. Here, too, the underlying consideration is that a wind farm is often not operated at the rated power and then the limit of the connection capacity is not reached. Consequently, the wind farm can then in principle be dimensioned greater than the grid connection point is dimensioned.

This particularly does not take into account the problem that a dynamic limitation of the power to be fed in also comes into consideration. Here it is also accepted that, in the case where there is sufficient wind and a sufficient number of available wind power installations, that is to say when the farm could generate more power than the grid connection point allows, throttling must be performed, in order not to exceed the power limit of the grid connection point.

The German Patent and Trademark Office has also searched the following prior art in the priority application relating to the present application: WO2018/006921A1, DE102012101928A1, DE102013207264A1, US2013/0178991A1, and U.S. Pat. No. 6,724,097B1.

### BRIEF SUMMARY

Provided herein is minimizing as much as possible any cutting back of a wind power installation, the wind farm or a wind power system.

A method for feeding in electrical power is proposed. This method uses a wind power system and such a wind power system comprises a wind farm. The wind power system may in this case consist exclusively of the wind farm, but may also include other units, particularly a photovoltaic installation and also or alternatively an electrical store.

It is provided that the wind power system feeds into an electrical supply grid at a grid connection point. This assumes a topology in which the electrical supply grid has at least one distribution grid and at least one further higher portion of the grid lying hierarchically above the distribution grid. In particular, it is provided that the grid connection point is arranged on the distribution grid, so that the wind power system therefore feeds into the distribution grid. A portion of the grid lying hierarchically above the distribution grid is such a portion to which the distribution grid is subordinate, in particular in such a way that a number of or many distribution grids are subordinated to this higher portion of the grid. In particular, the higher portion of the grid may have a higher voltage than the distribution grid. In particular, it comes into consideration that the distribution grid is a medium-voltage grid and the higher portion of the grid is a high-voltage grid or an extra-high-voltage grid in the sense that a person skilled in the art usually uses these terms. It also comes into consideration that the distribution grid is a high-voltage grid and the higher portion of the grid is an extra-high-voltage grid.

In any event, the grid connection point is connected to the distribution grid, so that the wind power system feeds into the distribution grid. It also comes into consideration that there is at least one further distribution grid, which is indirectly or directly connected to this distribution grid into which the wind power system feeds, so that a power exchange can be carried out between two or more such distribution grids. The proposed method comprises a number of steps.

Among these, in a detecting step, an initial feed-in limitation with respect to the grid connection point is detected. Such an initial feed-in limitation is one that prescribes a power limit up to which the wind power system can or may feed electrical power into the electrical supply grid. That may be particularly a current feed-in limitation, but also a feed-in limitation lying in the future, which is then also advisedly taken into account in the further steps for the corresponding future, and it may also concern a progression of a feed-in limitation, as still to be described later. The probably simplest case, on which the following explanations are based also partly for the sake of simplicity, is that in which the feed-in limitation has a fixed value, which at least initially is in the form of a temporarily fixed value.

This detection may mean particularly that a corresponding limit value, specifically the power limit, is transmitted from outside, that is to say is transmitted to the wind power system from outside the wind power system. In the detecting step, therefore, such a received power limit is evaluated and used as a basis for the further procedure. It also comes into consideration however that previously known conditions lead to a power limit. For example, a power limitation may be provided in dependence on a grid frequency of the electrical supply grid, or generally critical times are known, times in which a power limit should be taken into account and the power limit is then detected, that is to say determined, in dependence of these predetermined times.

It also comes into consideration that a power limit is closely tied to the grid connection point, that is to say is assigned to it, and for example a power limit at different levels may be received from outside, and then it should be checked whether the externally obtained power limit is relevant, that is to say is smaller than the limit closely assigned to the grid connection point.

In a basic checking step, it is then checked whether the farm power that can be generated from wind by the wind farm is limited by the initial feed-in limitation. In particular, it can be checked here whether it lies above the initial power limit, so that the wind farm is throttled in its power output by the initial power limit. In particular, it comes into consideration here that the wind farm is throttled to a power below the initial power limit.

Particularly whenever there is not only a wind farm in the wind power system, it comes into consideration however that the throttling may only come about as a result of the power generated altogether in the wind power system. In other words, the wind farm alone could therefore lie below the power limit, but together with a power that is additionally generated by a photovoltaic installation the sum of this power could indeed lie above the power limit. This may then nevertheless have a consequence for the power generation of the wind farm.

In the basic checking step, it is consequently checked whether the initial feed-in limitation is relevant at all, or whether the wind farm or the wind power system in any case is generating at that moment comparatively little power, which as a result lies below the power limit.

In an evaluating step, it is then evaluated whether the initial feed-in limitation, that is to say the initial power limit, can be increased. This only takes place of course whenever it has been found in the basic checking step that the farm power is being throttled in the first place.

Here it has particularly been recognized that there may be very different reasons for such an initial power limitation and these reasons, which may for example be central reasons, lead to a single limitation that is for example re-calculated on the basis of a generally applicable key. This is so because the feed-in limitation that is prescribed for the grid connection point is often caused by a superordinate power limitation, which is relevant to various participants, to put it in general terms, and is distributed among them. Such participants may be various feeders, which for their part respectively feed into the electrical supply grid. It may however also be caused by a power limit of the higher portion of the grid, to which distribution grids are a number of participants, which then receive a corresponding limitation.

This may then mean that the power limitation of the specific grid connection point does not necessarily have to be observed, as long as the overall superordinate objective, that is to say the superordinate power limit mentioned, is observed. Such a superordinate power limit, or else some other superordinate objective, that has led to this specific power limit at the grid connection point, may be very complex, which is still to be explained below. In any event, it often comes into consideration that the initial feed-in limitation, that is to say initial power limit, can be changed in special cases and/or when taking into account particular boundary conditions and/or when taking other measures.

Precisely that is found out in the evaluating step. And if the evaluating step was then successful to the extent that this power limit can be increased, that is carried out in a changing step. In the changing step, therefore, the initial feed-in limitation and then the initial power limit is increased to an increased feed-in limit or an increased power limit.

Correspondingly, electrical power above the initial feed-in limitation, that is to say above the initial power limit, can be fed in whenever a corresponding increase has been carried out in the changing step.

For this purpose, it is proposed that it is checked in the evaluating step whether the initial feed-in limitation can be changed by a redistribution of the limitation. Such a redistribution of the limitation is consequently the possibility of increasing the feed-in limitation entirely or partially at the grid connection point in that a redistribution of the limitation in the electrical supply grid is carried out. If, therefore, there is a feed-in limitation at the grid connection point, it is checked whether this feed-in limitation can instead be set for example at a neighboring grid connection point of another generator, that is to say whether the present grid connection point can allow more feeding in if the neighboring grid connection point allows less feeding in. A redistribution may also mean that the feed-in limitation of the grid connection point is transmitted to a transmission point from the distribution grid into another grid. In this case, therefore, the grid connection point would not be limited, or limited less, but instead the connection point mentioned of the distribution grid. Also in this respect it cannot generally be assumed that this is possible, but it should be checked. Criteria for this are still to be given and explained below.

It also comes into consideration that a redistribution of the limitation to a number of points in the electrical supply grid is used. Then, therefore, not only two points are considered, and part of the limitation displaced from one point to the other, but in this case more than two points are considered, and the redistribution takes place in such a way that only at the end is the sum of the limitations of all of the points observed. This may also take place dynamically. Here, too, it should of course be checked whether such a redistribution of the limitation is possible in the first place, in particular whether the initial feed-in limitation of the grid connection point is of such a kind at all that it does not concern the grid connection point directly, but is only the result of the overall consideration mentioned. In other words, that would be the case particularly whenever the actual limitation is not required at all for the specific grid connection point, but there is at some other point a general limitation, which can be differently divided according to choice among the points mentioned. It should therefore be checked whether a redistribution comes into consideration.

It is preferably proposed that, for checking whether the initial feed-in limitation can be changed by a redistribution of the limitation, it is checked whether at least one of the following criteria exists, the criteria also being able to overlap in terms of their content. It is also possible for a number of criteria to exist at the same time, or else one criterion may be a condition for another criterion.

One possible criterion is whether the feed-in limitation does not result from the distribution grid. This is particularly based on the idea that the distribution grid consequently does not require any limitation and this limitation requirement only comes from outside. Therefore, as long as the limitation prescribed from outside, that is to say from outside the distribution grid concerned, is also observed to the outside by the distribution grid, the initial limitation can possibly be handled differently in the distribution grid, specifically in such a way that it can be increased. For example, to mention a simple graphic example, there may be in the neighborhood of the wind power system a large consumer, which at that moment also for its part needs a large amount of power. Then, the wind power system may in this case possibly feed in more power than was allowed on the basis of the initial power limit, because this power that is actually too high or a part of it, can flow directly into the consumer mentioned by way of example, and consequently is not even detectable outside the distribution grid.

Coming into consideration as a further criterion is whether the feed-in limitation is prescribed by the higher portion of the grid. Here, too, it has been recognized that such a superordinate power limitation has been distributed among individual feeders, such as the wind power system, although a different distribution also comes into consideration, or is even more advisable. Here, too, it may be possible to put into practice the idea that exceeding the initial power limit at the wind power system may be acceptable or even advisable if it is adapted to other generators and/or consumers. Here, too, it therefore comes into consideration that the initial power limit may be exceeded as long as it does not have any effect outside the distribution grid. It also comes into consideration, however, that the power fed in altogether in the distribution grid and that experiences this superordinate power limitation may also be partially transmitted to another portion of the grid, such as for example a neighboring distribution grid, instead of to the higher portion of the grid that has prescribed this power limitation.

It is proposed as a criterion that it is checked whether a portion of the grid that is not overloaded has been detected. This is based particularly on the idea that an overloaded portion of the grid may lead to a power limitation although there is also a portion of the grid that is not overloaded and can take more power. Reducing the loading of the overloaded portion of the grid can therefore then be achieved not only by less power being fed in, which the initial power limit would require, but by an at least partial redistribution of the power being carried out, in which the power in or to the portion of the grid that is overloaded is reduced and in or to the portion of the grid that is not overloaded is increased. Consequently, this is also a measure by which it is possible to avoid reducing the wind power that is generated. At the same time, a weakening of the grid is also avoided, since—in simplified terms—reducing a feeding in of power even though it is ultimately not necessary can lead to a weakening of the grid.

A further criterion is to establish that no physical limitation of the grid connection point exists. A physical limit or limitation of the grid connection point may be provided for example by the overall power of the transformer or a line to the grid connection point, or by lines in the distribution grid that are only designed for a specific power, which must not be exceeded in order not to endanger the elements mentioned. A limitation of a transformer from the distribution grid to the higher portion of the grid is not included in this. This is so because such a physical limit could possibly be circumvented, in that either excessive power does not reach such a transformer in the first place and/or in that the power or part of it leaves the distribution grid at another connection point.

It also comes into consideration that for example a grid operator controls the feeding in of electrical power by for example penalty costs being incurred for power exceeding a certain limit value, that is to say particularly if a feed-in limitation is exceeded. What initially appears to be a commercial aspect is however a control tool, which can be used to control a behavior of the feeders, such as the behavior of the wind power system, because this specifically has the effect that fluctuating wind power cannot readily be passed on. Also, an adaptation of the penalty costs mentioned may be performed on the basis of the behavior of the feeders, in order also as a result to control better the power feed-in. To this extent, an adaptation of this control process can be performed by changing the penalty costs.

This is where the proposed solution comes in, a solution that has recognized such a, at least possible, control tool and proposes in this respect that this should also be taken into account. Since such penalty costs may be prescribed particularly by the grid operator, the corresponding wind power system can and will also obtain the corresponding information on this from the grid operator. As a result, this can be easily taken into account.

If it is therefore found that the feed-in limitation is linked to penalty costs, it can be calculated whether observing the upper power limit is more profitable, or deliberately feeding in power above the power limit. As a result, a grid operator can control the feeders concerned by prescribing such penalty costs.

It is proposed as a further criterion to check whether the feed-in limitation is part of a number of feed-in limitations of the distribution grid that are prescribed such that the sum of the feed-in limitations lies below a limitation for the sum, it being possible for at least one feed-in limitation to be higher as long as the sum of the feed-in limitations remains below a limitation for the sum. In this case, it is possible in principle for power to be exchanged, or power quotas to be exchanged, specifically between a number of feeders. Thus, for example, a feeder which at a given time can feed in more than its power limit may use the quota or part of the quota of a neighboring generator that is unable at that moment to feed in up to the initial power limit.

This may be relevant for example if one of the feeders is a wind farm and another feeder is a photovoltaic installation. There are then often cases where the weather situation means that there is a large amount of wind energy but little solar energy, or vice versa. Then, when there is strong wind, for example, a wind farm or wind power system may feed in above the initial power limit, if there is such a limit, if a photovoltaic installation that is connected to the same distribution grid can at that moment feed in less power and lies below its initial power limit. In this simple example, the wind power system can then feed in a greater amount of power above the initial power limit equivalent to the amount by which the photovoltaic installation remains below its initial power limit because of little solar energy.

However, such utilization of other quotas does not have to be restricted to a distribution grid, but may also be exchanged between a number of distribution grids, or even with higher portions of the grid.

According to a further criterion, it is checked whether at least one further power generator that feeds into the same distribution grid is provided with a feed-in limitation that the further powered generator is not fully utilizing. This criterion therefore specifically concerns the idea that quotas are exchanged between power generators. It particularly concerns the idea that a power generator, which may in principle also be referred to as a feeder, can feed in more power than the initial power limitation if the further power generator, that is to say the further feeder, feeds in correspondingly less power than the initial power limit.

Consequently, here it is particularly proposed that a power level by which the at least one further power generator lies below a power limit to be observed by it is offered as a tradable capacity to other feeders, in particular other power generators such as the wind power system, fully or partially for use. Therefore, a power level by which the at least one further power generator lies below its power limit is detected and this is given as a tradable capacity, which may also be referred to as a tradable quota, to other feeders or power generators. As a result, power generators that could feed in above their power limit can feed in nevertheless, by using such an unused quota.

A further proposed criterion takes the form that the initial feed-in limitation has its cause in the higher portion of the grid and a neighboring distribution grid can take up power, in order in this way to make it possible to exceed the initial feed-in limitation. The distribution grid is therefore coupled to a further neighboring distribution grid directly, at least in some other way than via the higher portion of the grid. Power can therefore be transmitted not only to the higher portion of the grid, but also to the neighboring distribution grid. If there is a constriction in the higher portion of the grid, or a similar problem that leads to a cause of the initial feed-in limitation, a power transmission to the higher portion of the grid may actually be correspondingly reduced. Further use of the neighboring distribution grid then however allows power to be transmitted by this means instead. As a result, the initial feed-in limitation, and consequently correspondingly the initial power limit, can be exceeded. This is so because this power that is actually too high is removed for other purposes, specifically to the neighboring distribution grid.

Consequently, various criteria have been proposed, criteria that can also be combined, also partially overlap and have the effect that an initial feed-in limitation possibly need not be observed, or not completely. A reduction of power can therefore be averted, or at least lessened. This is particularly based on the consideration that it has been recognized that an initial feed-in limitation is often not essential and that it is important to detect what is the reason for this initial feed-in limitation. There may be cases in which such an initial feed-in limitation must be observed. There are, however, also many cases, arising particularly as a result of the aforementioned criteria, in which an initial feed-in limitation can be circumvented. It has also been recognized here that it is not sufficient to establish this circumventability in principle, but also to take corresponding measures in light of the reason for this circumventability, in order that the limitation can be at least partially circumvented.

According to one embodiment, it is proposed that, in the changing step, the increased power limit is specified as a time-based progression and also or alternatively a feed-in forecast is determined, providing a time-based progression of the power to be fed in for a forecast time period.

Here it has particularly been recognized that a feed-in limitation may often also depend on grid conditions and other circumstances, which can change, sometimes can change quickly, and/or sometimes can change continuously. In the evaluation of the cause of the initial power limitation, it may also be found whether there is a reason for the initial power limitation that is variable, and possibly how variable it is, that is to say how it can change. This can be used to derive a kind of schedule for increasing the power limit. Such a schedule to this extent forms a time-based progression of the increased power limit.

For example, the reason for the power limitation may lie in a grid recovery of a remote portion of the grid. The progression of such a grid recovery can be predicted quite well, and correspondingly such a time-based progression of the increased power limit can likewise be predicted. Another possibility of specifying such a time-based progression may be based on knowing with respect to consumers in the vicinity that they for example increase or reduce their power requirement at certain points in time, and correspondingly the increased power limit may be correspondingly high or low whenever the power consumption of this consumer is the reason, or one of the reasons, why the wind power system can increase the initial power limit.

For example, measuring the power consumption of consumers may also be carried out to determine an increased power limit. This may particularly be additionally carried out, in order for example to adapt a forecast. This may particularly be advisable whenever in this case a measured value lies above the forecast; this may then create additional grid connection capacity for the wind power system.

It also comes into consideration however that, on the basis of a wind forecast, an increased power limit is evidently only needed for certain periods of time. If, therefore, the wind speed falls for example, which may be known on the basis of a weather forecast, an increased power limit may initially be desired but is later no longer needed because of the wind dropping. In this case, the time-based progression of the increased power limit would be such that it slowly falls, until it has reached the initial power limit, and then goes below it.

Instead of prescribing the increased power limit as a time-based progression, or in addition to this, it is also possible to determine a feed-in forecast, which provides for a forecasting time period a time-based progression of the power to be fed in. This may also include a time-based progression or segment of the time-based progression in which the power to be fed in itself lies below the initial power limit, at least temporarily. Such a feed-in forecast may for example be based on weather data, that is to say a weather forecast. Particularly whenever a power quota is taken into account, that is to say whenever a kind of power trade-off takes place between a number of feeders or between feeders and consumers, such a feed-in forecast may be helpful, in order that it is clear when the wind power system concerned needs power capacities or can release power capacities. Preferably, such a feed-in forecast is accompanied by an accuracy indication, which states how great a deviation from this forecast or this forecast progression is to be expected. In this way, predictability on the basis of such a feed-in forecast can be improved.

According to one embodiment, it is proposed that electrical power that the wind farm generates from wind and cannot be fed in because of the initial feed-in limitation is used for supplying loads within the farm. This of course also includes the case where the power limit could have been increased, but it is nevertheless still so low that a reduction of the power fed in is still required, albeit to a lesser extent.

Here it has particularly been recognized that, as a result, a reduction of the power generated from wind can be prevented or at least reduced. In this case, controllable loads are those that can increase their power consumption when required. Such loads may be for example cold stores, if the wind farm or the wind power system is located in the vicinity of such a cold store, which may also be part of an electric charging station that has an adjoining service station and is supplied by the wind power system or forms part of the wind power system. Such a cold store usually has such a high thermal capacity that the temperature can also be kept in an acceptable range for several hours without power or without much power. The cooling may therefore be started when such a case of the initial feed-in limitation occurs.

Another controllable consumer may be one that converts electricity into another form of energy, for example into methane or hydrogen.

According to a further configuration, it is proposed that, in the case of a coupling of the feed-in limitation to penalty costs for an exceedance, a level of exceedance by which the power fed in exceeds the initial power limit is assessed. In particular, it is proposed to set up a penalty cost function for the penalty costs in dependence on the level of exceedance. This allows the exceedance to be numerically assessed and further processed.

For this purpose, it is also proposed in particular that a tariff function for a feed-in tariff is set up in dependence on the level of exceedance. This creates an incentive for the operator of the wind power system not to instigate an exceedance as far as possible, or only to a certain degree. This allows controllability to be achieved, since the higher the penalty costs are, the more likely it is that the operator of the wind power system could decide not to increase excessive power any further. Therefore, such a tariff function creates the possibility of external control intervention.

It is particularly also proposed in this respect that an exceedance of the fed-in power beyond the initial power limit is controlled in dependence on a comparison of the penalty cost function and the tariff function. In particular, this may be configured in such a way that an exceedance of the fed-in power is undertaken at such a level that the penalty cost function does not exceed the tariff function. It can therefore be controlled in such a way that the penalty costs do not exceed the tariff. This is also a control means that even the grid operator can use. After all, the grid operator knows the tariff costs and can then control the exceedance of the initial power limit indirectly by correspondingly setting the penalty cost function.

According to one embodiment, it is proposed that the feeding in is additionally controlled in dependence on a maximum limit, which lies above the initial power limit and must not be exceeded. Correspondingly, at least a two-stage check should be performed, specifically first as to whether the initial power limit can be exceeded, and if that is the case whether the increased power limit lies below the maximum limit, or that the increased power limit is limited by the maximum limit. As a result, technically essential upper limits can particularly also be taken into account. Consequently, damage to elements can particularly also be avoided. Such a maximum limit is preferably formed as a time-based progression, which particularly allows short-term increases. Short-term increases in power, even above a technically caused permanent upper limit, may be advisable for example in the case of thermally caused upper limits. In the case of thermal upper limits, a short-term increase in power on account of thermal inertia of the system or a corresponding element may be tolerable for a short time.

It is preferably checked whether the feed-in limitation is relevant at that moment or in a future time period. This check is carried out in particular at least in the detecting step and/or in the basic checking step. As a result, it is in any event possible for there to be an immediate response, or in the case of future feed-in limitations for there to be corresponding preplanning. Thus, for example, steps for implementing the increase in the power limit, which need some time to implement, may already be initiated in advance.

According to one configuration, it is proposed that, for feeding in electrical power above the initial power limit, electrical power, in particular the power exceeding the initial power limit, is fed at least to a consumer connected in the distribution grid. This particularly also concerns the case where the consumer connected in the distribution grid has served as a criterion for determining that an exceedance of the initial power limit is possible in the first place. This may likewise be based on the case where the cause of the initial feed-in limitation does not lie in the distribution grid.

This proposal made here may, however, also be used in other cases, or be used in addition. In any event, it is proposed here to allow a consumer of the same distribution grid to receive power, in order in this way to be able to generate and feed in this power without however power limits in other areas of the electrical supply grid, for example at a transmission point from the distribution grid to the higher portion of the grid, having to be exceeded. Such specific feeding of power to a consumer may take place for example by controlling the voltage in the electrical supply grid, for example by correspondingly feeding in reactive power through decentralized generators in the relevant portion of the grid and/or through tapped transformers. Preferably proposed for this is a communication structure via which the wind power system communicates with the consumer. Apart from communication via radio networks or telephone networks, including cellular networks, ripple control may also be provided, in which the wind power system sends a signal over a power line to the consumer or consumers concerned.

As a further variant, it is proposed that control of the at least one consumer takes place dependent on general criteria, such as for example the time of day, solar irradiation or wind speed. The wind power system can then for example rely on the consumer taking up a fixed minimum power at a predetermined time of day, or it is fixed that the consumer consumes an agreed minimum power as from a predetermined wind speed, which it can for example easily measure or take from a weather report. This may also be referred to as an intertripping circuit or intertripping control.

According to one embodiment, the method is characterized in that, for feeding in electrical power above the initial power limit, tradable capacities of other power generators of the distribution grid are used. It has been recognized here that there are often a number of generators that feed into the same distribution grid, and such generators have however a differing requirement for exceeding the initial power limit. Such capacities are traded here, and consequently form tradable capacities, specifically capacities of power that can be additionally fed in.

This proposal may also be based on the variant that the presence of such tradable capacities or the possibility of trading such capacities in the first place was also the criterion, or was one of the criteria, for determining that the initial power limit can be exceeded in the first place. However, also this proposed measure can be combined with different criteria and this measure can also be combined with other measures or this measure can form a supplementary measure.

This is particularly proposed for the purpose that tradable capacities of photovoltaic installations, electrical stores and/or further wind farms that are connected to the distribution grid are used. It has particularly been recognized here that power from wind power installations or wind farms, that is to say power from wind, is often available counter-cyclically in relation to power from photovoltaic installations, that is to say solar energy. When therefore the wind farm can feed in a large amount of power, a photovoltaic installation can often only feed in little power, or vice versa. Such proposed tradable capacities, specifically tradable power capacities, are mostly available as a result. It may also be that a local weather situation, for example a thunderstorm, causes lower feeding in than is assumed for the photovoltaic installation, but there is more wind. The unused capacity can then be passed on from the photovoltaic installation or a photovoltaic installation farm to the wind farm. It also comes into consideration that, for example, a neighboring wind farm is not feeding in, or only at a reduced level, because of maintenance, and as a result has capacities available.

Similarly, electrical stores that feed into the distribution grid may have tradable capacities, or at least can take up excess power and temporarily store it. This can also avoid or reduce cutting back the wind farm in the case of a corresponding initial feed-in limitation. It may also be advisable for operation of a store not to feed in stored amounts of power or to feed it in at a later time. This frees up feed-in capacities, which can be passed on against payment to the wind power system as grid connection power.

According to one embodiment, the method is characterized in that the wind power system additionally comprises a photovoltaic installation and optionally an electrical store, which can store at least an amount of energy equivalent to 10 minutes rated power of the wind farm. The store therefore has a significant storage capacity. This also exploits the fact that a wind farm and photovoltaic installations often operate counter-cyclically and consequently when there is little power from one system the other system provides and can feed in a large amount of power. This is the special situation where the wind farm and the solar installations are combined in the same wind power system. As a result, such power balancing on the basis of the counter-cyclical power generation mentioned of the two systems can already be performed within the wind power system, whereby the initial feed-in limitation can be at least partially circumvented directly.

It is also proposed in this respect that the wind farm, the photovoltaic installation and possibly the electrical store are respectively characterized by a rated power and the sum of these rated powers forms a total power. If, therefore, all of these systems are operated at rated power, which however is rarely the case at the same time, the wind power system with the two or three systems could together generate the total power as a sum of all their rated powers.

This however only serves for purposes of illustration and it is instead proposed here that the grid connection point is limited in a fixed manner to a fixed power value below the total power and above or in the region of the greatest rated power of the rated powers mentioned. The total power can therefore not be fed in at all because of the limitation of the grid connection point. To this extent, the grid connection point is limited in a fixed manner to such a fixed power value; in particular, such a limitation is essential because it may also be caused by physical factors. Furthermore, this fixed power value is above the greatest rated power.

If therefore, for example, the wind farm has the greatest rated power, the fixed power value lies in the region or above the rated power of the wind farm and below the total power. The grid connection point is to this extent underdimensioned with regard to the wind power system as a whole, but is well dimensioned, or overdimensioned, for the wind farm alone. This may possibly also have the effect of producing reserves such that, when the wind farm is operating at rated power, for example some PV power can also be generated and fed in. Here, too, this is based on the idea that it is scarcely likely that the wind farm and the photovoltaic installation can achieve rated power at the same time, but instead it should be expected for the rated power of the two to be reached counter-cyclically in relation to one another.

In this respect it is thus additionally proposed, at least optionally, that the grid connection point is dynamically limited to a dynamic power value below the greatest rated power. Therefore proposed is a dynamic limitation, which consequently makes the grid connection point itself appear underdimensioned for the wind farm. This limitation is however dynamic and can possibly be increased, and allow at least more power than the rated power of the wind farm.

Such a dynamic limitation of the grid connection capacity should be understood as meaning that the fixed power value to which the grid connection point is limited is made up of a basic component and a dynamic component. For example, with respect to rated power of the wind farm as 100%, the limitation may be made up of an 80-percent basic component and a dynamic component of 30%, so that the fixed power value to which the grid connection point is limited in a fixed manner is 110%. Therefore, more than 110% can also not be physically fed in via this grid connection point, and to this extent this fixed power value is fixed as an upper limit that cannot be exceeded.

This fixed power value as an absolute upper limit, that is to say the 110% mentioned by way of example, is made up however of a basic component, for example of 80%, and a dynamic component of 30%. The basic component is consequently in principle present, so that therefore feeding in of 80% is in principle always possible, provided that there are no other reasons to prevent it. The 110% can however only be achieved if this dynamic component of 30% is also provided. For this purpose, this dynamic component must also first be obtained as an additional grid connection capacity. This may take place for example by a corresponding capacity also being available in the connected distribution grid, for example when there is a feeder that is not fully utilized.

A wind power system for feeding electrical power into an electrical supply grid at a grid connection point is also proposed. Such a wind power system comprises at least one wind farm. It may also additionally include a photovoltaic installation and instead or in addition an electrical store, which may store at least an amount of energy amounting to 10 minutes of rated power of the wind farm.

Presupposed for this wind power system is a grid topology in which the electrical supply grid to which the wind power system is connected via the grid connection point has at least one distribution grid and at least one further higher portion of the grid lying hierarchically above the distribution grid. There are therefore at least two grid levels and the wind power system is connected via the grid connection point to the distribution grid, that is to say on the lower level.

The wind power system also comprises a detecting unit for detecting an initial feed-in limitation with respect to the grid connection point, which prescribes an initial power limit up to which the wind power system can feed electrical power into the electrical supply grid. Such a detecting unit may particularly be a process computer which is connected to an external unit via which it obtains the initial feed-in limitation. The initial feed-in limitation can therefore be transmitted for example as a corresponding command signal to the detecting unit, that is to say the process computer mentioned. It also comes into consideration, however, that internal criteria, for example a time-dependent feed-in limitation, are already implemented in the detecting unit, particularly the process computer mentioned, and as a result the initial feed-in limitation is detected.

The detecting unit may also be part of a central farm computer.

Also provided is a checking unit for checking whether the farm power that can be generated from wind by the wind farm is limited by the initial feed-in limitation. In particular, the checking unit checks whether the farm power that can be generated from wind lies above the initial power limit, so that the wind farm is throttled in its power output by the initial power limit, in particular is throttled to a power below the initial power limit. The checking unit may for this purpose be connected as a process computer to a central farm computer and in this way obtain information about the farm power that can be generated from wind by the wind farm. Furthermore, the checking unit may obtain the initial feed-in limitation as information from the detecting unit and use it as a basis for the check. The checking unit may also be part of a central farm computer.

Also provided is an evaluating unit, for evaluating whether the initial power limit can be increased if it has been found in the checking unit that the farm power is being throttled. Particularly, the evaluating unit may be formed here as a process computer and check whether the initial feed-in limitation can under certain circumstances nevertheless be exceeded. For this purpose, the evaluating unit may particularly also obtain information from the detecting unit concerning the initial feed-in limitation, including the cause of this feed-in limitation. The evaluating unit may be part of a central farm computer.

Also provided is a changing unit for increasing the initial power limit to an increased power limit if it has been found in the evaluating unit that the power limit can be increased. The changing unit may also be formed as a process computer and be coupled to the evaluating unit, in order to obtain from it information as to whether the initial power limit can be increased in the first place. Furthermore, the changing unit may for example obtain further information from the detecting unit in order to be able to deduce from this how much, and perhaps also for what time, the power limit can be increased. The changing unit may similarly also be part of a central farm computer, specifically particularly of the central farm computer that in a variant may comprise the detecting unit, the checking unit, the evaluating unit and the changing unit. According to one embodiment, the units may be separated or structured there as corresponding logical units.

Also provided is a feeding-in device for feeding in electrical power above the initial power limit if the initial power limit has been increased to an increased power limit by the changing unit. Particularly, the feeding-in device may be activated for this purpose by the changing unit and/or the central farm computer. The feeding-in device may particularly be an inverter for generating and feeding in an electrical alternating current. The feeding-in device may however also be the entirety of all the inverters of the individual wind power installations of the wind farm. In the simplest case, the changing unit may also activate the feeding-in device, and enable it to increase the initial power limit, in such a way that the power limit is raised. Correspondingly, the changing unit may also reset the power limit again when raising is no longer possible.

It is thus also proposed for this wind power system that it is checked by the evaluating unit whether the initial feed-in limitation can be changed by a redistribution of the limitation. This may be checked particularly as explained above in connection with the explanations concerning the feeding-in method, in particular as explained in connection with the possible criteria for checking for the existence of a redistribution of the limitation. The evaluating unit may in this case particularly bring together and evaluate the corresponding information. It may obtain this information particularly from the detecting unit.

In particular, it is proposed that the wind power system is prepared to perform a method according to at least one embodiment described above. In particular, a central farm computer is provided for this.

In particular, this farm computer may comprise the detecting unit, the checking unit, the evaluating unit and the changing unit. Such a or else another central farm computer is preferably connected via a farm information network to each wind power installation of the wind farm, in order thereby to send information to the wind power installations and/or to obtain information from the wind power installations. In addition, such a central farm computer is preferably connected or connectable to an external unit such as an external control center, in particular a control center of a grid operator, in order to obtain information from there and/or transmit information to there.

### BRIEF DESCRIPTION OF THE SEVERAL VIEWS OF THE DRAWINGS

The invention is explained in more detail below by way of example on the basis of embodiments with reference to the accompanying figures.

FIG. 1 shows a wind power installation in a perspective representation.

FIG. 2 shows a wind farm in a schematic representation.

FIG. 3 schematically shows a wind power system together with part of an electrical supply grid with further generators and consumers.

### DETAILED DESCRIPTION

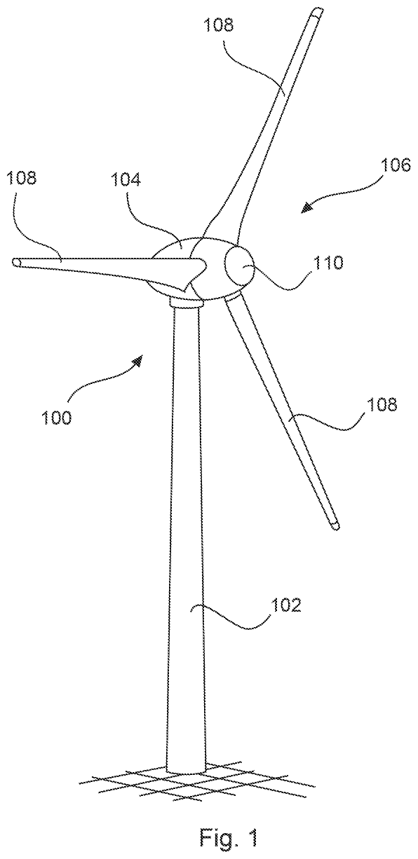

FIG. 1 shows a wind power installation 100 with a tower 102 and a nacelle 104. Arranged on the nacelle 104 is a rotor 106 with three rotor blades 108 and a spinner 110. During operation, the rotor 106 is set in a rotary motion by the wind, and thereby drives a generator in the nacelle 104.

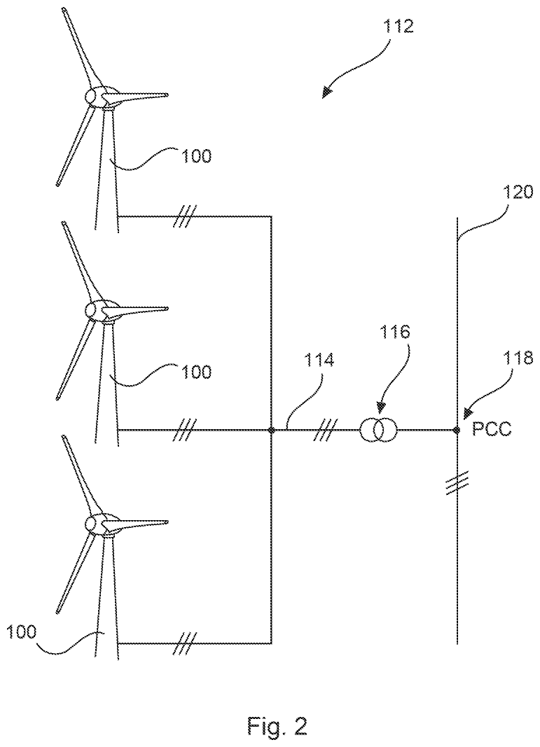

FIG. 2 shows a wind farm 112 with, by way of example, three wind power installations 100, which may be the same or different. The three wind power installations 100 are consequently representative of essentially any number of wind power installations of a wind farm 112. The wind power installations 100 provide their power, to be specific in particular the electricity generated, by way of an electrical farm grid 114. In this case, the electricity or power respectively generated by the individual wind power installations 100 is added together and there is usually a transformer 116, which steps up the voltage in the farm in order then to feed into the supply grid 120 at the feed-in point 118, which is also referred to generally as the PCC. FIG. 2 is just a simplified representation of a wind farm 112, which for example does not show any controller, although there is of course a controller. It is also possible for example for the farm grid 114 to be differently designed, in that for example there is also a transformer at the output of each wind power installation 100, to name just one other exemplary embodiment.

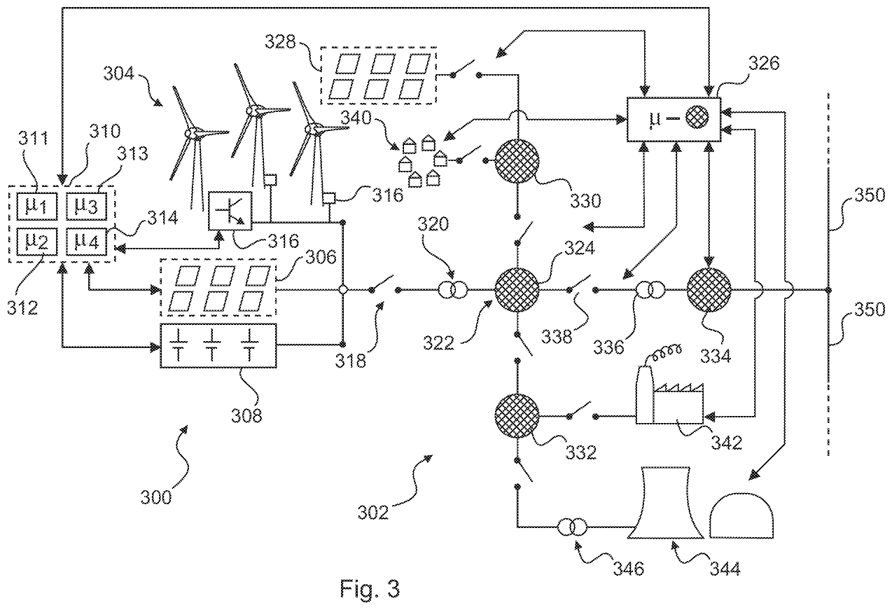

FIG. 3 schematically shows a wind power system 300, specifically essentially in the left half of FIG. 3, and part of an electrical supply grid 302, specifically essentially in the right half of FIG. 3. The wind power system 300 is here by way of example a wind farm 304, which is symbolized by way of example by three wind power installations, also a photovoltaic installation 306 and an electrical store (e.g., battery) 308. Also provided is a central farm computer 310, which can activate the wind farm 304, but also the other elements of the wind power system 300, specifically particularly also the photovoltaic installation 306 and the electrical store 308.

The central farm computer 310 has for this a detecting unit 311, a checking unit 312, an evaluating unit 313 and a changing unit 314. These four units may be respectively provided as a microprocessor and are therefore referred to as μ₁, μ₂, μ₃ and μ₄. The central farm computer 310 can activate the wind farm 304, the photovoltaic installation 306 and the electrical store 308, which may be formed as a battery store, and also receive information from there, which is respectively indicated by a double-headed arrow.

The communication of the central farm computer 310 with the wind farm 304 may particularly also take place individually with corresponding feeding-in devices (e.g., inverters) 316. Each of the wind power installations may have such a feeding-in device 316, which can particularly generate an electrical three-phase alternating current that can be fed in. This is indicated by the symbol of a semiconductor circuit. FIG. 3 only clearly shows such a feeding-in device 316 for one of the three symbolically represented wind power installations, and for the others such a feeding-in device 316 is only indicated. Particularly, the changing unit 314 may be connected to the feeding-in devices 316, in order to transmit to them a signal for changing the electrical power to be fed in.

The wind power installation of the wind farm 304 and also the photovoltaic installation 306 and possibly the electrical store 308 feed into a first distribution grid 324 at a grid connection point 332 via a farm disconnecting switch 318 and a farm transformer 320. They then also feed into the electrical supply grid 302, of which the first distribution grid 324 is part.

The central farm computer 310 also communicates with an external control center 326, which can be operated particularly by a grid operator responsible for the electrical supply grid 302 or part of it. Here, too, information can be exchanged in both directions. In particular, the receiving unit (e.g., receiver or transceiver) 311 may communicate with the external control center 326 and also obtain an initial feed-in limitation from there as information. Furthermore, the central farm computer 310, in particular the receiving unit 311, may also obtain information on the origin or cause of such an initial feed-in limitation. Such an initial feed-in limitation is in this case given with respect to the grid connection point 322.

The external control center (e.g., controller) 326 may in this case also transmit further initial feed-in limitations to other feeders, in particular to a symbolically represented second photovoltaic installation 328. The second photovoltaic installation 328 is not part of the wind power system 300, but feeds in independently, and therefore may also have an independent switch. The second photovoltaic installation 328 could also feed into the electrical supply grid 302 via a transformer, which for the sake of simplicity is not shown here.

Many switches, similar to the farm switch 318, are in any case symbolically depicted in the electrical supply grid 302 of FIG. 3, particularly intended to illustrate that there is the possibility of disconnection at various points. The grid operator may possibly also activate such switches from its external control center 326, and enquire their position, which is respectively indicated by corresponding double-headed arrows. Simply for the purpose of allowing them to be seen better, all of the switches similar to the farm switch 318 are shown in FIG. 3 as open. The normal operating case is that all of these switches are closed.

Apart from the first distribution grid 324, a second distribution grid 330 and a third distribution grid 332 are shown. These three distribution grids 324, 330 and 332 may have the same hierarchical level and, in particular, also the same voltage level, even though that is not an absolute requirement.

Also depicted is a higher portion of the grid 334, lying above the first distribution grid 324 and consequently also above the second and third distribution grids 330 and 332. This higher portion of the grid 334 is in this case connected inter alia via a high-voltage transformer 336 and a grid disconnecting switch 338 to the first distribution grid 324.

Also symbolically shown is a settlement (populated area) 340, which is connected to the second distribution grid 330. Furthermore, a factory 342 is connected as an industrial consumer to the third distribution grid 332. For illustrative purposes, a conventional power plant 344 is also connected to the third distribution grid 332 via a high-voltage transformer 346. This representation may however also illustrate a situation in which the conventional power plant 344 is connected to a portion of the grid of a higher order. Particularly, the power plant may for example also be connected directly to the higher portion of the grid 334.

In principle, the distribution grids 324, 330 and 332, the higher portion of the grid 334, the consumers 340 and 342 and also the feeders 328 and 344 that are shown can be seen as part of the electrical supply grid, in any event from the viewpoint of the wind power system 300. From another viewpoint, the wind power system 300 itself could be understood as part of the electrical supply grid.

On the basis of this schematic representation of a setup of an electrical supply grid 302 with the wind power system 300, at least part of the idea can be explained. If the central farm computer 310, particularly the receiving unit 311, receives an initial feed-in limitation from the control center 326, this can initially be established by the detecting unit 311. This information may be passed on to the checking unit 312. The checking unit can then check on this basis whether the farm power that can be generated from wind by the wind farm is limited by this initial feed-in limitation. In other words, the checking unit 312 can particularly check whether there is sufficient wind in the first place for such an initial feed-in limitation to have any influence at all on the current feeding-in state of the wind farm.

If it has been found that the initial feed-in limitation is relevant for the wind farm, the evaluating unit 313 can then evaluate whether nevertheless this initial power limitation can possibly be increased. If this is the case, the changing unit 314 can possibly increase the initial power limit that has been prescribed by the initial feed-in limitation, and thereby also correspondingly determine a value of the increase or a new value after the increase for the power to be fed in. It can then pass the result to the feeding-in devices 316, so that the wind power installations of the wind farm 304 can behave correspondingly. Otherwise, the wind power installations may also have been informed in this way of the previously prescribed, and then possibly initially also implemented, initial feed-in limitation.

Various redistributions of the limitation come into consideration, some of which are now to be explained by way of example on the basis of the illustrated setup of FIG. 3.

A variant that also serves well for purposes of illustration is that the grid operator, represented by its control center 326, desires a power limitation for the transmission of power into the higher portion of the grid 334. The higher portion of the grid 334 is otherwise shown in FIG. 3 for purposes of illustration with a further disconnecting sub-line 350, which is intended to indicate that the higher portion of the grid 334 may also be part of a transmission grid, or leads to a transmission grid. This desired limitation, given by way of example, may particularly also come into consideration for reasons of protecting or controlling such a transmission grid, specifically a limitation of the power which, to be clear, is intended to be transmitted via the high-voltage transformer 336. The grid disconnecting switch 338 is of course closed in this case.

This limitation may therefore have been distributed uniformly among the feeders, particularly among the regenerative feeders, specifically the wind power system 300 and the second photovoltaic installation 328.

For the wind power system 300, it has been found that this initial feed-in limitation actually limits the feeding in; here specifically the wind farm 304 must or should reduce its generated power. The reason for this may be, to be clear, inclement fall weather with strong wind and little sunshine. In this case, however, the second photovoltaic installation 328, which may for example be greater with regard to its rated power than the photovoltaic installation 306 of the wind power system 300, lies far below the feed-in limitation prescribed for it. If the wind power system 300 knows that, specifically because the evaluating unit 313 particularly has evaluated it, the wind power system 300 can correspondingly feed in more power than the initial feed-in limitation prescribed for it has dictated. This is so because the power limitation actually provided for the high-voltage transformer 336 is then nevertheless observed.

Otherwise, this example that has been given also comes into consideration whenever, unlike the situation illustrated in FIG. 3, the second photovoltaic installation 328 is not connected to the second distribution grid 330, but to the same distribution grid 324.

Also coming into consideration as a further variant, which may also be combined with those mentioned above, is that it is known that the symbolically represented factory 342, that is to say a large consumer, needs a very large amount of power, or even has announced an increased power requirement. Such information may be provided for example by the factory 342 or some other large consumer to the external control center 326. The latter can pass on this information to the central farm computer 310, so that this information finally also arrives at the evaluating unit 313.

If, therefore, this high or even increased power requirement of the factory 324 is known, there is likewise the possibility that the wind power system 300 exceeds the actually prescribed initial feed-in limitation. This increased power then flows however, at least partially, directly to the large consumer, that is to say here to the factory 342, without this power having to pass the high-voltage transformer 336. To this extent, this also constitutes a redistribution, because the initial feed-in limitation, which has its cause in the higher portion of the grid 334, can be distributed differently, in that the excess power is as it were made to bypass the problem point. Also to this extent, the high-voltage transformer 336 is mentioned for reasons of better illustration, without it actually having to be the problem. This high-voltage transformer 336 may to this extent be understood as the transmission point to the higher portion of the grid 334.

Other redistributions of the limitation also come into consideration, specifically using quite generally the two further distribution grids, that is to say the second distribution grid 330 and the third distribution grid 332. It may also come into consideration here that each of these distribution grids is for its part connected via another connection point to the higher portion of the grid 334 and in this way the power flows can consequently be changed.

To this extent, the redistribution of the limitation, which applies to any embodiments, may also be referred to synonymously as a redistribution of the power.

A further variant of the redistribution of the limitation or redistribution of the power may be that a power limitation is controlled by way of a cost function. For example, a power limitation which is defined such that exceeding this power limitation leads to a cost levy or to a reduction of the feed-in tariff may be prescribed. The wind power system 300 shown may in this case then check whether it is advisable to exceed the initial feed-in limitation and as a result to accept a reduction of the tariffs, or instead to feed power into the electrical store 308, particularly if the limitation is for a limited time. As a result, the control of the wind power system can be indirectly performed from outside.

It also comes into consideration however that such technically effective controls over costs or tariffs may have different effects for the sum of all those involved, that is to say particularly the feeders and consumers, resulting altogether in stable control. Particularly, prescribing costs for exceeding the initial feed-in limitation may be accompanied by reducing costs for consumers that take power, as is the case for example with so-called off-peak electricity, with which even end consumers such as small households can be supplied with power at more favorable rates at night time than during the day. If therefore the wind power system exceeds the initial feed-in limitation, with the result that the tariff is reduced, in return the households of the settlement 340 for example can be supplied with electricity at more favorable rates, and this offer is then also taken up. Other feeders, such as the conventional power plant 344 shown by way of example, can save primary energy by feeding in less, which is not the case in principle with a wind farm system, unless the wind power system has an electrical store. Correspondingly, it makes more sense for a conventional power plant to comply with a power limitation.

All of this can have the overall effect that altogether a desired power balance is obtained, because for example, although the wind farm feeds in more power, a conventional feeder feeds in less and a consumer then to some extent consumes more power.

It has consequently been recognized that it can be assumed that in future a calculation of the use of the grid that is dependent on full grid utilization and grid capacity may be advisable in distribution and transmission grids. Then a variable assessment of the grid connection power particularly comes into consideration, and similarly a dynamic restriction.

Consequently proposed is a solution for controlling a wind power installation, a wind farm and/or a wind power system in a way corresponding to these boundary conditions.

Particularly proposed for this are wind farms with a variable grid connection power. This also allows a variable grid charge to be taken into account.

An increase in the yield of the installations or avoidance of losses of yield can be realized.

For this purpose, it is taken into account that, in probably the simplest case, in future there may be a simple, temporary and/or dynamic limitation of the grid connection capacity, specifically to a dynamic connection value as an alternative or in addition to feed-in management. It is then also possible consequently to respond to this dynamic connection value by simply restricting the farm power.

It is however proposed, particularly for income-optimized operation, to check for example at farm level whether the limitation results from the distribution grid or is because of a restriction from the higher levels of the grid.

It is also proposed to check whether the limitation concerns the current feeding in or future feeding in and whether possible losses of yield may occur.

If the limitation originates from the higher levels of the grid and cutting back is threatened, there is the chance of secondary marketing of the volumes of electricity in the distribution grid, whereby cutting back can then nevertheless be avoided.

If there is no possibility of secondary marketing, under some circumstances there is the possibility of also at least partially using temporarily grid connection capacity of other feeders in the vicinity, for example of photovoltaic installations or wind farms with still available grid connection power, or else of wind farms that are currently undergoing maintenance.

Coming into consideration as a further possibility that can also be added is to use loads within the farm instead of lowering the power generated.

Only when there is no possibility of increasing the grid connection capacity must the wind farm or the wind power system be cut back.

It has been recognized that the proposed solutions can additionally also have commercial advantages.

If specifically for example the dynamic grid connection power not only comprises a fixed limit but is coupled to a price, in a further embodiment the wind power installation or the wind system may carry out a simple cost appraisal. In this case it may be checked, particularly additionally, whether on a price basis the expected feeding in justifies an increase of the grid connection capacity. Here, too, it should be checked whether under some circumstances unused grid connection capacities of neighboring regenerative feeders can be used.

A further application area for regenerative feeders with a variable grid connection power are combined systems of wind power installations, photovoltaic installations and stores. These can together form a wind power system. For example, the grid connection power of such a wind power system may be limited to 80% of the power of the wind power installations and have for example a 30-percent dynamic component. Consequently, the grid connection power would be variably restricted to a value of 80% to 110% of the rated power of the wind farm of such a wind power system.

It has however been recognized in this respect that the wind power installations on the one hand and the photovoltaic installations on the other hand usually generate large amounts of power at different times, so that the restriction to a value just a little above the rated value of the wind farm alone may be sufficient. Often, even that value is not reached, which can be taken into account by the dynamic component given by way of example of 30%.

1. A method for feeding in electrical power using a wind power system into an electrical supply grid at a grid connection point, the method comprising:
detecting a first feed-in limitation associated with the grid connection point, the first feed-in limitation representing an initial power limit, the wind power system being permitted to feed the electrical power into the electrical supply grid up to the initial power limit, wherein:
the wind power system includes at least one wind farm,
the electrical supply grid has at least one distribution grid and at least one higher grid portion that is hierarchically above the at least one distribution grid, and the at least one distribution grid is subordinate to the at least one higher grid portion, and
the grid connection point is connected to the at least one distribution grid,
determining whether farm power that is capable of being generated from wind by the wind farm is greater than the initial power limit such that the wind farm is throttled to a power below the initial power;
in response to determining that the wind farm is throttled, determining whether the initial power limit is capable of being increased by at least redistributing the first feed-in limitation;
in response to determining that the initial power limit is capable of being increased, increasing the initial power limit to an increased power limit; and
in response to increasing the initial power limit to the increased power limit, feeding in the electrical power above the initial power limit.

2. The method as claimed in claim 1, wherein determining whether the first feed-in limitation is redistributable includes determining whether at least one criterion is satisfied from a list of criteria including:
the first feed-in limitation is not prescribed by the at least one distribution grid;
the first feed-in limitation is prescribed by the at least one higher grid portion;
a portion of the electrical supply grid that is not overloaded is detected;
no physical limitation of the grid connection point exists,
the first feed-in limitation is associated with penalty costs for exceeding the first feed-in limitation;
the first feed-in limitation is one of a plurality of feed-in limitations of the at least one distribution grid that are set such that a sum of the plurality of feed-in limitations is below a limitation for the sum of the plurality of feed-in limitations, and the first feed-in limitation is permitted to be increased on a condition that the sum of the plurality feed-in limitations remains the limitation for the sum of the plurality feed-in limitations;
at least one further power generator that feeds into the same distribution grid is associated with a second feed-in limitation and the at least one further power generator is not fully utilizing the second feed-in limitation, and a power level by which the at least one further power generator lies below the second feed-in limitation is offered as a tradable capacity to wind power systems fully or partially; and
the first feed-in limitation is caused by the at least one higher grid portion and a neighboring distribution grid is capable of taking up power for exceeding the first feed-in limitation.

3. The method as claimed in claim 1, comprising:
specifying the increased power limit as a time-based progression; and/or
determining a feed-in forecast that provide time-based progression of power to be fed in for a forecast time period.

4. The method as claimed in claim 1, comprising:
supplying controllable loads within the wind farm by electrical power, generated by the wind farm from wind, that is not fed in the electrical supply grid in response to reaching the first feed-in limitation.

5. The method as claimed in claim 1, wherein the first feed-in limitation is associated with penalty costs for exceeding the first feed-in limitation.

6. The method as claimed in claim 14, comprising:
controlling the feeding in of the electrical power based on a maximum limit that is above the initial power limit, wherein the maximum limit is not to be exceeded.

7. The method as claimed in claim 1, comprising:
determining whether the first feed-in limitation is currently applicable or applicable for a future time period.

8. The method as claimed in claim 1, wherein for feeding in the electrical power above the initial power limit, power exceeding the initial power limit is fed at least to a consumer connected in the distribution grid.

9. The method as claimed in claim 1, wherein:
for feeding in electrical power above the initial power limit, tradable capacities of other power generators of the at least one distribution grid are used.

10. The method as claimed in claim 1, wherein the wind power system includes:
a photovoltaic installation; or
batteries configured to store at least an amount of energy equivalent to ten minutes of a rated power of the wind farm.

11. A wind power system for feeding electrical power into an electrical supply grid, at a grid connection point, comprising:
at least one wind farm, the electrical supply grid having at least one distribution grid and at least one higher grid portion that is hierarchically above the at least one distribution grid, the at least one distribution grid being subordinate to the at least one higher grid portion, and the grid connection point being connected to the at least one distribution grid; and
a central farm computer configured to:
detect a first feed-in limitation associated with the grid connection point, the first feed-in limitation representing an initial power limit, the wind power system being permitted to feed electrical power into the electrical supply grid up to the initial power limit;
determine whether farm power that is capable of being generated from wind by the wind farm is greater than the initial power limit such that the wind farm is throttled to a power below the initial power limit;
in response to determining that the wind farm is throttled, determine whether the initial power limit is capable of being increased by at least redistributing the first feed-in limitation;
in response to determining that the initial power limit is capable of being increased, increase the initial power limit to an increased power limit; and
in response to increasing the initial power limit to the increased power limit, feeding in electrical power above the initial power limit.

12. (canceled)

13. The method as claimed in claim 5, comprising determining a level by which the power fed in exceeds the initial power limit.

14. The method as claimed in claim 13, wherein the initial power limit is determined by:
setting a penalty cost function, for the penalty costs, based on the level by which the power fed in exceeds the initial power limit;
setting a tariff function for a feed-in tariff based on the level by which the power fed in exceeds the initial power limit; and
controlling the level by which the power fed in exceeds the initial power limit based on comparing the penalty cost function and the tariff function.

15. The method as claimed in claim 7, wherein determining whether the first feed-in limitation is currently applicable or applicable for the future time period is performed when detecting the first feed-in limitation and/or determining whether the farm power is greater than the initial power limit.

16. The method as claimed in claim 9, wherein the tradable capacities of photovoltaic installations, batteries and/or further wind farms that are connected to the at least one distribution grid.

17. The method as claimed in claim 10, wherein the wind farm and the photovoltaic installation are respectively associated with a rated power and a sum of rated powers of the wind farm and the photovoltaic installation form a total rated power, the grid connection point is limited in a fixed manner to a fixed power value below the total rated power and above a largest rated power of the rated powers.

18. The method as claimed in claim 17, wherein the grid connection point is dynamically limited to a dynamic power value below the largest rated power.

19. The method as claimed in claim 10, wherein the wind farm, the photovoltaic installation and the electrical store are respectively characterized by a rated power and a sum of rated powers of the wind farm, the photovoltaic installation and the electrical store form a total rated power, the grid connection point is limited in a fixed manner to a fixed power value below the total rated power and above a largest of the rated powers.
